(19) United States
(12) Patent Application Publication
(10) Pub. No.: US 2026/0134451 A1
(43) Pub. Date: May 14, 2026

(54) TERMINAL APPARATUS, CONTROL METHOD, AND NON-TRANSITORY COMPUTER READABLE STORAGE MEDIUM

(71) Applicant: LY Corporation, Tokyo (JP)

(72) Inventors: Kazuhiro NINOMIYA, Tokyo (JP); Reiya YAMAGUCHI, Tokyo (JP)

(21) Appl. No.: 19/278,576

(22) Filed: Jul. 23, 2025

(30) Foreign Application Priority Data
Nov. 14, 2024 (JP) 2024-198859

(51) Int. Cl. G06Q 30/0251; G06F 16/3329; H04L 51/02

(52) U.S. Cl. CPC G06Q 30/0257; G06F 16/33295; H04L 51/02

(57) ABSTRACT

A terminal apparatus according to the present application includes an extraction unit that extracts a search query form conversation information on a user in a chat service, a generation unit that generates an advertisement link for displaying an advertisement based on the extracted search query, and a display processing unit that displays the generated advertisement link in the chat service.

### CROSS-REFERENCE TO RELATED APPLICATIONS

The present application claims priority to and incorporates by reference the entire contents of Japanese Patent Application No. 2024-198859 filed in Japan on Nov. 14, 2024.

### BACKGROUND OF THE INVENTION

### 1. Field of the Invention

The present invention relates to a terminal apparatus, a control method, and a non-transitory computer readable storage medium having stored therein a control program.

### 2. Description of the Related Art

Conventionally, a technology for providing, together with a search result, an advertisement that is linked to a search query input by a user is known.

Patent Literature 1: Japanese Laid-open Patent Publication No. 2017-194845

However, in the conventional technology, an advertisement is distributed on condition that a user inputs a search query in a search service, and therefore, there is room for improvement in efficiently distributing an advertisement.

### SUMMARY OF THE INVENTION

A terminal apparatus according to the present application includes an extraction unit that extracts a search query form conversation information on a user in a chat service, a generation unit that generates an advertisement link for displaying an advertisement based on the extracted search query, and a display processing unit that displays the generated advertisement link in the chat service.

### BRIEF DESCRIPTION OF THE DRAWINGS

FIG. 1 is a diagram illustrating a process that is performed by a terminal apparatus according to one embodiment;

FIG. 2 is a block diagram illustrating a configuration example of an information processing system according to one embodiment;

FIG. 3 is a diagram illustrating a configuration example of an information processing apparatus according to one embodiment;

FIG. 4 is a diagram illustrating an example of user information;

FIG. 5 is a diagram illustrating a configuration example of a user terminal according to one embodiment;

FIG. 6 is a diagram illustrating an example of application information;

FIG. 7 is a diagram illustrating an example of LLM information;

FIG. 8 is a flowchart illustrating the flow of a process that is performed by the user terminal according to one embodiment; and

FIG. 9 is a diagram illustrating an example of a hardware configuration.

### DETAILED DESCRIPTION OF THE PREFERRED EMBODIMENTS

Modes (hereinafter, described as “embodiments”) for carrying out a terminal apparatus, a control method, and a control program according to the present application will be described in detail below with reference to the drawings. Meanwhile, the terminal apparatus, the control method, and the control program according to the present application are not limited by the embodiments below. In addition, in each of the embodiments described below, the same components are denoted by the same reference symbols, and repeated explanation will be omitted.

### Embodiment

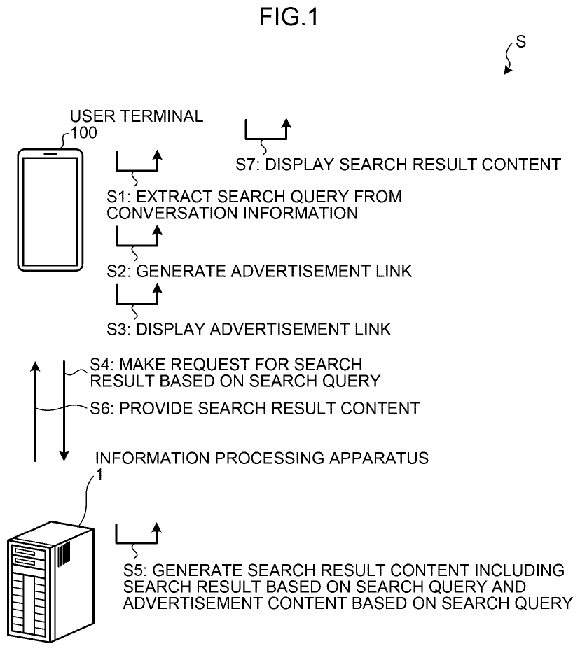

A process that is performed by a terminal apparatus according to one embodiment will be described below with reference to FIG. 1. FIG. 1 is a diagram illustrating a process that is performed by the terminal apparatus according to one embodiment. Meanwhile, FIG. 1 illustrates an example of operation of an information processing system S that includes a terminal apparatus (a user terminal 100) according to one embodiment.

As illustrated in FIG. 1, the information processing system S according to one embodiment includes an information processing apparatus 1 and the user terminal 100.

As illustrated in FIG. 1, the information processing system S according to one embodiment extracts a search query from conversation information on a user in a chat service, generates an advertisement link for displaying an advertisement based on the extracted search query, and displays the generated advertisement link in the chat service.

Specifically, firstly, the user terminal 100 extracts a search query from the conversation information on the user in the chat service (Step S1). More specifically, the user terminal 100 stores therein, in advance, Large Language Models that are trained to extract a search query from the conversation information. The user terminal 100 trains the LLM by, for example, a search query that the user inputs at the time of using a search service. In other words, the user terminal 100 extracts a search query that has been input by the user in the past, from the conversation information by using the trained LLM. Further, the user terminal 100 may train the LLM by a search query that is input by the user when conversion is achieved with respect to an advertisement that is displayed in search engine advertising. In other words, the user terminal 100 extracts, from the conversation information, a search query by which an advertisement that is highly likely to achieve conversion is displayed.

Meanwhile, the conversation information may include not only a content of utterance that is input by the user, but also utterance information on a conversation partner of the user.

Subsequently, the user terminal 100 generates the advertisement link for displaying the advertisement based on the extracted search query (Step S2). Specifically, the user terminal 100 generates, as the advertisement link, a Uniform Resource Locator (URL) that designates a search result screen that is displayed when a search query is input in a search service. Meanwhile, the search result screen includes an advertisement that is linked to the search query. Further, the advertisement link is not limited to the URL that designates the search result screen including an advertisement, but may be a URL that designates an advertisement page to which display is transitioned when the advertisement that is displayed in a linked manner with the search query is selected. In other words, the advertisement link may be a URL that displays at least the advertisement that is linked to the search query.

Subsequently, the user terminal 100 displays the generated advertisement link (Step S3). For example, the user terminal 100 displays the advertisement link in a talk room for the conversation partner in the chat service. The advertisement link is displayed as utterance of a third person other than the user and the conversation partner. The advertisement link is displayed for only the user between the user and the conversation partner. Further, when the user gives a permission, the advertisement link may be displayed for the conversation partner. Furthermore, the advertisement link may be displayed so as to cut into the conversation between the user and the conversation partner, or may be displayed at a timing at which the conversation between the user and the conversation partner is paused (a timing after a lapse of a predetermined time or more since last utterance). Moreover, the advertisement link may be displayed at a timing at which display of the advertisement link for the user is permitted.

Subsequently, when the user performs operation of selecting the advertisement link, the user terminal 100 makes a request to the information processing apparatus 1 for a search result based on the search query that is associated with the advertisement link (Step S4). Specifically, the user terminal 100 transmits the URL that is displayed as the advertisement link to the information processing apparatus 1. Meanwhile, for example, the user terminal 100 may store therein, in advance, a search result (except for an advertisement) that was displayed in response to input of a search query by the user in the past, and make a request to the information processing apparatus 1 for only an advertisement that is displayed based on the search query.

Subsequently, the information processing apparatus 1 generates a search result content that includes the search result based on the search query and an advertisement content based on the search query (Step S5). Specifically, the information processing apparatus 1 generates the search result content that is the search result screen including the search result that is retrieved based on the search query and an advertisement that is linked to the search query. Meanwhile, when the user terminal 100 makes a request for only the advertisement, the information processing apparatus 1 generates the advertisement as the search result content.

Subsequently, the information processing apparatus 1 provides the generated search result content to the user terminal 100 (Step S6).

Subsequently, the user terminal 100 displays the search result content (Step S7). For example, the user terminal 100 displays the search result content in the talk room for the conversation partner in the chat service. The search result content is displayed as utterance of a third person other than the user and the conversation partner. The search result content is displayed for only the user between the user and the conversation partner. Further, when the user gives a permission, the search result content may be displayed for the conversation partner. Furthermore, the search result content may be displayed so as to cut into the conversation between the user and the conversation partner, or may be displayed at a timing at which the conversation between the user and the conversation partner is paused (a timing after a lapse of a predetermined time or more since last utterance). Moreover, the search result content may be displayed at a timing at which display of the search result content for the user is permitted.

In this manner, according to the user terminal 100 of the present disclosure, by extracting a search query from conversation information on the user and displaying the search result content including the advertisement, it is possible to distribute, from the information processing apparatus 1, an advertisement based on a behavior (conversation) other than a search behavior of the user. In other words, according to the present disclosure, it is possible to improve advertisement distribution efficiency.

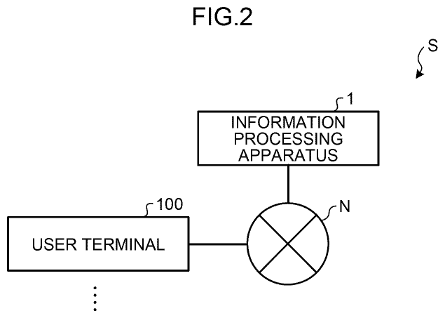

A configuration example of the information processing system S according to one embodiment will be described below with reference to FIG. 2. FIG. 2 is a block diagram illustrating a configuration example of the information processing system S according to one embodiment. As illustrated in FIG. 2, the information processing system S according to one embodiment includes the information processing apparatus 1 and the plurality of user terminals 100 that are connected to each other in a wired or wireless manner via the network N. The network N is, for example, a certain network, such as the Internet, a Wide Area Network (WAN), or a Local Area Network (LAN).

The information processing apparatus 1 is a server apparatus that implements an information processing method according to one embodiment. The information processing apparatus 1 generates the search result content that includes the search result and the advertisement content based on the search query that is transmitted from the user terminal 100, and provides the search result content to the user terminal 100.

Furthermore, the information processing apparatus 1 is an information processing apparatus that cooperates with the plurality of user terminals 100 and provides an Application Programming Interface (API) service or the like for various kinds of applications (hereinafter, referred to as applications) and various kinds of data to the plurality of user terminals 100, and is implemented by a server apparatus, a cloud system, or the like.

Moreover, the information processing apparatus 1 may be an information processing apparatus that provides a certain Web service online to the plurality of user terminals 100. For example, the information processing apparatus 1 may provide, as the Web service, an Internet connection, a search service, a Social Networking Service (SNS), an Electronic Commerce (EC), an electronic payment, an online game, an online banking, an online trading, an accommodation and ticket reservation, video and music distribution, news, a map, a route search, a route guide, route information, service status information, weather information, or the like. In reality, the information processing apparatus 1 may cooperate with various kinds of servers that provide Web services as described above, and mediate the Web services or handle processes of the Web services.

The user terminal 100 is a terminal apparatus that is carried by the user. As the user terminal 100, an arbitrary type of terminal apparatus, such as a smartphone, a desktop personal computer (PC), a notebook PC, or a tablet PC, may be used. The user terminal 100 transmits various kinds of information to the information processing apparatus 1 or the like, and receives information that is provided from the information processing apparatus 1 or the like. The user terminal 100 extracts a search query from conversation information on a user in a chat service, generates an advertisement link for displaying an advertisement based on the extracted search query, and displays the generated advertisement link in the chat service.

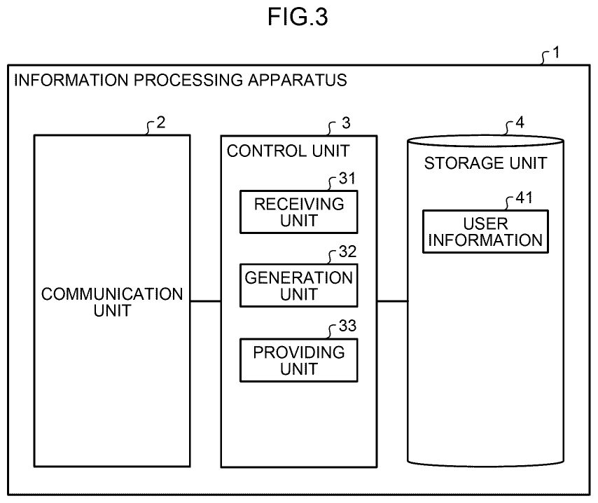

A configuration example of the information processing apparatus 1 will be described below with reference to FIG. 3.

FIG. 3 Is a Diagram Illustrating a Configuration example the information processing apparatus 1 according to one embodiment. As illustrated in FIG. 3, the information processing apparatus 1 includes a communication unit 2, a control unit 3, and a storage unit 4. The control unit 3 includes a receiving unit 31, a generation unit 32, and a providing unit 33. The storage unit 4 stores therein user information 41.

The communication unit 2 is implemented by, for example, a Network Interface Card (NIC) or the like. The communication unit 2 is connected to a network in a wired or wireless manner.

The control unit 3 is a controller and implemented by causing a processor, such as a Central Processing Unit (CPU) or a Micro Processing Unit (MPU), to execute various kinds of programs (corresponding to an example of the information processing program) that are stored in a storage device inside the information processing apparatus 1 by using a Random Access Memory (RAM) or the like as a work area. Further, the control unit 3 is a controller and may be implemented by, for example, an integrated circuit, such as an Application Specific Integrated Circuit (ASIC), a Field Programmable Gate Array (FPGA), or a General Purpose Graphic Processing Unit (GPGPU).

The storage unit 4 is implemented by, for example, a semiconductor memory device, such as a RAM or a Flash Memory, or a storage device, such as a hard disk or an optical disk.

The user information 41 is information on a user.

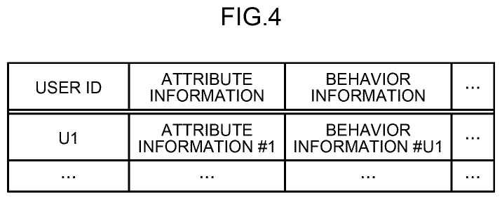

FIG. 4 is a diagram illustrating an example of the user information 41. As illustrated in FIG. 4, the user information 41 includes items such as a “user ID”, “attribute information”, and “behavior information”.

The “user ID” is identification information for identifying a user. The “attribute information” is information on an attribute of the user. Examples of the attribute information include a psychographic attribute and a demographic attribute. The “behavior information” is information on a history of a behavior of the user, and includes a search behavior, a purchase behavior, a visit behavior, a behavior of browsing a news article, posted information, or the like, and conversation information in a chat service.

Each of functions (the receiving unit 31, the generation unit 32, and the providing unit 33) of the control unit 3 of the information processing apparatus 1 will be described below.

The receiving unit 31 receives various kinds of information. When the user performs operation of selecting the advertisement link via the user terminal 100, the receiving unit 31 receives a request for a search result based on a search query that is associated with the advertisement link.

The generation unit 32, when receiving the request from the user terminal 100, generates the search result content that includes the search result based on the search query and the search result based on the search query. Specifically, the generation unit 32 generates the search result content that is the search result screen including the search result that is retrieved based on the search query and an advertisement that is linked to the search query. Meanwhile, when the user terminal 100 makes a request for only the advertisement, the generation unit 32 generates the advertisement as the search result content.

The providing unit 33 provides the generated search result content to the user terminal 100.

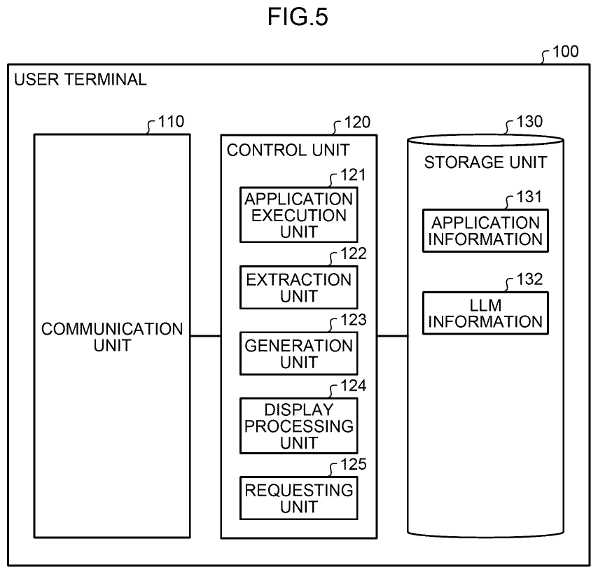

A configuration example of the user terminal 100 will be described below with reference to FIG. 5.

FIG. 5 is a diagram illustrating a configuration example of the user terminal 100 according to one embodiment. As illustrated in FIG. 5, the user terminal 100 includes a communication unit 110, a control unit 120, and a storage unit 130. The control unit 120 includes an application execution unit 121, an extraction unit 122, a generation unit 123, a display processing unit 124, and a requesting unit 125. The storage unit 4 stores therein application information 131 and LLM information 132.

The communication unit 110 is implemented by, for example, an NIC or the like. The communication unit 110 is connected to a network in a wired or wireless manner.

The control unit 120 is a controller and implemented by causing a processor, such as a CPU or an MPU, to execute various kinds of programs (corresponding to an example of the information processing program) that are stored in a storage device inside the user terminal 100 by using a RAM or the like as a work area. Further, the control unit 120 is a controller and may be implemented by, for example, an integrated circuit, such as an ASIC, an FPGA, or a GPGPU.

The storage unit 130 is implemented by, for example, a semiconductor memory device, such as a RAM or a flash memory, or a storage device, such as a hard disk or an optical disk.

The application information 131 is information on an application that is installed in the user terminal 100.

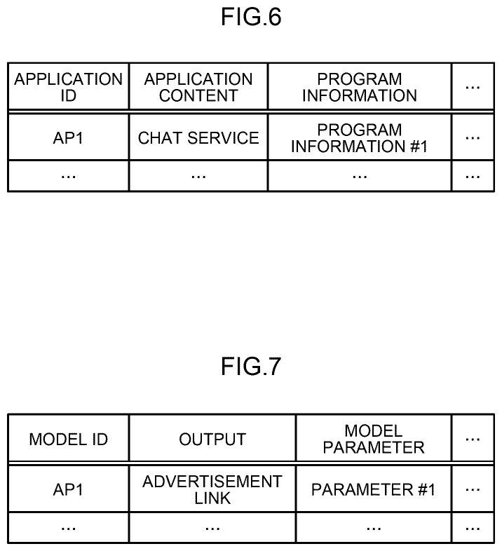

FIG. 6 is a diagram illustrating an example of the application information 131. As illustrated in FIG. 6, the application information 131 includes items such as an “application ID”, an “application content”, and “program information”. The user terminal 100, when an application is downloaded from the information processing apparatus 1 or the like in accordance with operation performed by the user, issues a new application ID and updates the application information 131.

The “application ID” is identification information for identifying an application that is executable by the user terminal 100. The “application content” is information that indicates a content of a service that is provided by the application. The “program information” is information on a program of the application.

The LLM information 132 is information on a Large Language Models (LLM) for generating an advertisement link from a search query. FIG. 7 is a diagram illustrating an example of the LLM information 132. As illustrated in FIG. 7, the LLM information 132 includes items such as a “model ID”, “output”, and a “model parameter”.

The “model ID” is identification information for identifying a trained model. The “output” is information that indicates a content that is output by the model. The “model parameter” is information that indicates a parameter of the model.

Each of functions (the application execution unit 121, the extraction unit 122, the generation unit 123, the display processing unit 124, and the requesting unit 125) of the control unit 120 of the user terminal 100 will be described below.

The application execution unit 121 executes an application in accordance with operation that is performed by the user. Specifically, the application execution unit 121 reads, from the application information 131, program information on an application that is selected by operation performed by the user, and executes the program information.

The extraction unit 122 extracts a search query from the conversation information on the user in the chat service. For example, the extraction unit 122 trains the LLM by a search query that is input by the user when the user uses a search service. In other words, the extraction unit 122 extracts a search query that has been input in the past by the user, from the conversation information by using the trained LLM. Further, the extraction unit 122 may train the LLM by a search query that is input by the user when conversion is achieved with respect to an advertisement that is displayed in search advertising. In other words, the extraction unit 122 extracts, from the conversation information, a search query by which an advertisement that is highly likely to achieve conversion is displayed. Meanwhile, the conversation information may include not only a content of utterance that is input by the user, but also utterance information on a conversation partner of the user.

The generation unit 123 generates the advertisement link for displaying the advertisement based on the extracted search query. Specifically, the generation unit 123 generates, as the advertisement link, a URL that designates a search result screen that is displayed when a search query is input in a search service. Meanwhile, the search result screen includes an advertisement that is linked to the search query. Further, the advertisement link is not limited to the URL that designates the search result screen including an advertisement, but may be a URL that designates an advertisement page to which display is transitioned when the advertisement that is displayed in a linked manner with the search query is selected. In other words, the advertisement link may be a URL that displays at least the advertisement that is linked to the search query.

The display processing unit 124 displays the generated advertisement link. For example, the display processing unit 124 displays the advertisement link in a talk room for the conversation partner in the chat service. The advertisement link is displayed as utterance of a third person other than the user and the conversation partner. The advertisement link is displayed for only the user between the user and the conversation partner. Further, when the user gives a permission, the advertisement link may be displayed for the conversation partner. Furthermore, the advertisement link may be displayed so as to cut into the conversation between the user and the conversation partner, or may be displayed at a timing at which the conversation between the user and the conversation partner is paused (a timing after a lapse of a predetermined time or more since last utterance). Moreover, the advertisement link may be displayed at a timing at which display of the advertisement link for the user is permitted.

The display processing unit 124 displays the search result content. For example, the display processing unit 124 displays the search result content in the talk room for the conversation partner in the chat service. The search result content is displayed as utterance of a third person other than the user and the conversation partner. The search result content is displayed for only the user between the user and the conversation partner. Further, when the user gives a permission, the search result content may be displayed for the conversation partner. Furthermore, the search result content may be displayed so as to cut into the conversation between the user and the conversation partner, or may be displayed at a timing at which the conversation between the user and the conversation partner is paused (a timing after a lapse of a predetermined time or more since last utterance). Moreover, the search result content may be displayed at a timing at which display of the search result content for the user is permitted.

When the user performs operation of selecting the advertisement link, the requesting unit 125 makes a request to the information processing apparatus 1 for a search result based on the search query that is associated with the advertisement link. Specifically, the requesting unit 125 transmits the URL that is displayed as the advertisement link to the information processing apparatus 1. Meanwhile, for example, the requesting unit 125 may store therein, in advance, a search result (except for an advertisement) that was displayed in response to input of a search query by the user in the past, and make a request to the information processing apparatus 1 for only an advertisement that is displayed based on the search query.

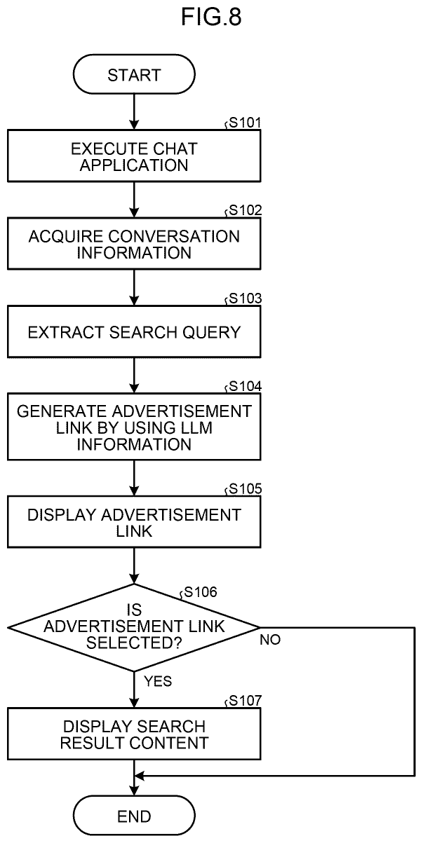

A flow of a process performed by the user terminal 100 according to one embodiment will be described below with reference to FIG. 8. FIG. 8 is a flowchart illustrating the flow of the process performed by the user terminal 100 according to one embodiment.

As illustrated in FIG. 8, the control unit 120 executes a chat application (Step S101).

Subsequently, the control unit 120 acquires conversation information on the user in a chat service that is provided by the chat application (Step S102).

Then, the control unit 120 extracts a search query from the conversation information (Step S103).

Subsequently, the control unit 120 generates an advertisement link from the extracted search query by using the LLM information 132 (Step S104).

Then, the control unit 120 displays the generated advertisement link (Step S105), and determines whether or not the user selects the advertisement link (Step S106).

When the advertisement link is selected (Step S106: Yes), the control unit 120 displays the search result content that is transmitted from the information processing apparatus 1 (Step S107), and terminates the process. When the advertisement link is not selected (Step S106: No), the control unit 120 terminates the process.

Of the processes described in the embodiments above, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in each of the drawings are not limited to the information illustrated in the drawings.

Furthermore, the components of the apparatuses illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

For example, a part or whole of the storage unit 4 illustrated in FIG. 3 may be stored in a storage server or the like, instead of being stored in each of the apparatuses. In this case, each of the apparatuses accesses the storage server and acquires various kinds of information.

### Hardware Configuration

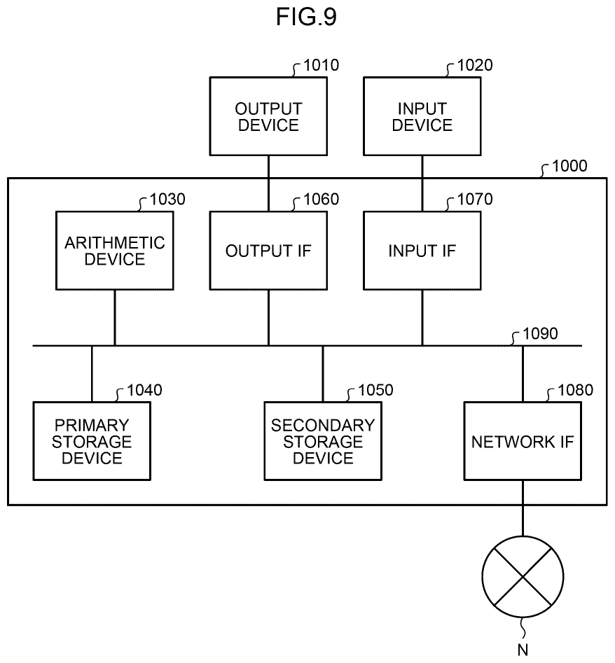

The information processing apparatus 1 and the user terminal 100 according to one embodiment as described above are implemented by, for example, a computer 1000 that is configured as illustrated in FIG. 9. FIG. 9 is a diagram illustrating an example of a hardware configuration. The computer 1000 is connected to an output device 1010 and an input device 1020, and an arithmetic device 1030, a primary storage device 1040, a secondary storage device 1050, an output Interface (IF) 1060, an input IF 1070, and a network IF 1080 are connected to one another via a bus 1090.

The arithmetic device 1030 operates based on a program that is stored in the primary storage device 1040 or the secondary storage device 1050, a program that is read from the input device 1020, or the like, and performs various kinds of processes. The primary storage device 1040 is a memory device, such as a RAM, that temporarily stores therein data that is used by the arithmetic device 1030 for various kinds of calculations. Further, the secondary storage device 1050 is a storage device in which data that is used by the arithmetic device 1030 for various kinds of calculations or various kinds of databases are registered, and is implemented by a Read Only Memory (ROM), a Hard Disk Drive (HDD), a flash memory, or the like.

The output IF 1060 is an interface for transmitting output target information to the output device 1010, such as a monitor or a printer, that outputs various kinds of information, and is implemented by, for example, a connector based on a certain standard, such as a Universal Serial Bus (USB), Digital Visual Interface (DVI), or High Definition Multimedia Interface (HDMI) (registered trademark). Further, the input IF 1070 is an interface for receiving information from various kinds of the input devices 1020, such as a mouse, a keyboard, and a scanner, and is implemented by, for example, a USB or the like.

Meanwhile, the input device 1020 may be a device that reads information from, for example, an optical recording medium, such as a Compact Disc (CD), a Digital Versatile Disc (DVD), or a Phase change rewritable Disk (PD), a magneto-optical recording medium, such as a Magneto-Optical disk (MO), a tape medium, a magnetic recording medium, a semiconductor memory, or the like. Further, the input device 1020 may be an external storage medium, such as a USB memory.

The network IF 1080 receives data from a different apparatus via the network N, sends the data to the arithmetic device 1030, and transmits data generated by the arithmetic device 1030 to a different apparatus via the network N.

The arithmetic device 1030 controls the output device 1010 and the input device 1020 via the output IF 1060 and the input IF 1070. For example, the arithmetic device 1030 loads a program from the input device 1020 or the secondary storage device 1050 onto the primary storage device 1040, and executes the loaded program.

For example, when the computer 1000 functions as the information processing apparatus 1 or the user terminal 100, the arithmetic device 1030 of the computer 1000 executes a program that is loaded on the primary storage device 1040, and implements the functions of the control unit 3 or the control unit 120.

### Effects

As described above, the terminal apparatus (the user terminal 100) according to one embodiment includes the extraction unit 122 that extracts a search query form conversation information on a user in a chat service, the generation unit 123 that generates an advertisement link for displaying an advertisement based on the extracted search query, and the display processing unit 124 that displays the generated advertisement link in the chat service.

With this configuration, the user terminal 100 is able to improve advertisement distribution efficiency.

Thus, some embodiments of the present application have been described in detail above based on the drawings, but the embodiments are described by way of example, and the present invention may be embodied in various different modes with various modifications and improvement based on knowledge of a person skilled in the art, in addition to the embodiments described in the section of the disclosure of the invention.

### Others

Of the processes described in the embodiments above, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in each of the drawings are not limited to the information illustrated in the drawings.

Furthermore, the components of the apparatuses illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

Moreover, the processes explained in the embodiments described above may be appropriately combined as long as processing contents do not conflict with each other.

In addition, the “unit (section, module, unit)” described above may be replaced with a “means”, a “circuit”, or the like. For example, the control unit 3 may be replaced with a control means or a control circuit.

According to one aspect of embodiments, it is possible to improve advertisement distribution efficiency.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal apparatus comprising:
an extraction unit that extracts a search query from conversation information on a user in a chat service;
a generation unit that generates an advertisement link for displaying an advertisement based on the extracted search query; and
a display processing unit that displays the generated advertisement link in the chat service.

2. The terminal apparatus according to claim 1, further comprising:
a requesting unit that makes a request to the information processing apparatus for an advertisement content based on the search query when the user selects the advertisement link, wherein
the display processing unit displays the advertisement content that is transmitted from the information processing apparatus in accordance with the request.

3. The terminal apparatus according to claim 2, wherein the display processing unit displays a search result content that includes the advertisement content and a search result based on the search query.

4. The terminal apparatus according to claim 3, wherein the search result is a search result that was retrieved based on the search query in the past by the user.

5. The terminal apparatus according to claim 3, wherein the search result is a search result that is retrieved based on the search query when the information processing apparatus receives a request for the advertisement content from the requesting unit.

6. The terminal apparatus according to claim 3, wherein the display processing unit displays the search result content at a timing that is designated by the user.

7. The terminal apparatus according to claim 3, wherein the display processing unit shares the search result content with a conversation partner of the user in the chat service.

8. The terminal apparatus according to claim 7, wherein the display processing unit shares the search result content with the conversation partner when the user gives a permission.

9. The terminal apparatus according to claim 1, wherein the extraction unit uses a model that is trained to output the search query while adopting the conversation information as input, and adopts the search query that is output from the model as an extraction result.

10. A control method that is implemented by a terminal apparatus, the control method comprising:
extracting a search query from conversation information on a user in a chat service;
generating an advertisement link for displaying an advertisement based on the extracted search query; and
displaying the generated advertisement link in the chat service.

11. A non-transitory computer readable storage medium having stored therein a control program that causes a computer to execute a process, the process comprising:
extracting a search query from conversation information on a user in a chat service;
generating an advertisement link for displaying an advertisement based on the extracted search query; and
displaying the generated advertisement link in the chat service.
